(19) United States
(12) Patent Application Publication
(10) Pub. No.: US 2011/0093730 A1
(43) Pub. Date: Apr. 21, 2011

(54) Portable Electronic Device and Power Management Method

(75) Inventor: Wei-Chen Chou, Taipei Hsien (TW)

(73) Assignee: WISTRON CORPORATION, Taipei Hsien (TW)

(21) Appl. No.: 12/905,351

(22) Filed: Oct. 15, 2010

(30) Foreign Application Priority Data
Oct. 19, 2009 (TW) 098135244

(51) Int. Cl. G06F 1/32; G06F 1/26

(52) U.S. Cl. 713/324; 713/300

(57) ABSTRACT

A power management method is to be implemented by a portable electronic device. The portable electronic device is coupled to an expansion device having at least one expansion unit, and supplies power to the expansion device. The power management method includes: (A) configuring the portable electronic device to detect whether a control command is received thereby; (B) configuring the portable electronic device to transmit a control signal corresponding to the control command to the expansion device in response to the control command; and (C) configuring the expansion device to cease supplying power to the at least one expansion unit in accordance with the control signal, thereby saving power.

### CROSS-REFERENCE TO RELATED APPLICATION

This application claims priority of Taiwanese application no. 098135244, filed on Oct. 19, 2009.

### BACKGROUND OF THE INVENTION

1. Field of the Invention

The invention relates to a portable electronic device, more particularly to a portable electronic device adapted for coupling to an expansion device.

2. Description of the Related Art

The demand for expanding functionality of portable electronic devices, such as notebook computers, global positioning system (GPS) receivers, and portable music players is increasing. For the notebook computer, functionality is often expanded by externally connecting an expansion device (dock) to the notebook computer. The expansion device includes a plurality of expansion units, such as a USB port, an optical disk drive, etc.

The expansion device is often supplied with power from a battery of the notebook computer, and since the expansion units of the expansion device are supplied with power regardless of whether a particular expansion unit is in use, unnecessary power is consumed and service life of the battery is reduced. It is thus desirable to cease supply of power to the expansion unit that is not in use.

### SUMMARY OF THE INVENTION

Therefore, one object of the present invention is to provide a portable electronic device adapted for coupling with an expansion device and capable of controlling supply of power by the expansion device to an expansion unit of the expansion device.

According to the present invention, there is provided a portable electronic device adapted for coupling with an expansion device (dock) and supplying power to the expansion device. The expansion device has a power controlling circuit and at least one expansion unit. The power controlling circuit receives power from the portable electronic device and is operable to control supply of power to the at least one expansion unit. The portable electronic device comprises a power supplying unit and a microcontroller.

The power supplying unit is for supplying power to the portable electronic device. The microcontroller is for outputting a control signal corresponding to a control command, and transmitting the control signal to the power controlling circuit of the expansion device. The power controlling circuit controls the supply of power to the at least one expansion unit in accordance with the control signal so that the at least one expansion unit is switched from a first power supply state to a second power supply state.

In an embodiment of the invention, the first power supply state is an on state, the second power supply state is an off state, and when the microcontroller transmits the control signal to the power controlling circuit of the expansion device, the power controlling circuit, in accordance with the control signal, ceases to supply power to the at least one expansion unit so that the at least one expansion unit is switched from the on state to the off state.

In an embodiment of the invention, the first power supply state is an off state, the second power supply state is an on state, and when the microcontroller transmits the control signal to the power controlling circuit of the expansion device, the power controlling circuit, in accordance with the control signal, supplies power to the at least one expansion unit so that the at least one expansion unit is switched from the off state to the on state.

Preferably, the portable electronic device further comprises an input unit coupled to the microcontroller and operable to output the control command. More preferably, the input unit is a keyboard having a plurality of hot keys corresponding to the at least one expansion unit, and pressing the hot keys results in output of the control command.

Preferably, the portable electronic device further comprises a transmission interface coupled to the microcontroller and the power supplying unit for transmitting the control signal and a power signal to the expansion device. More preferably, the transmission interface has a system management bus (SMbus) for transmitting the control signal.

Another object of the present invention is to provide a power management method to be implemented by the portable electronic device, the portable electronic device being coupled to an expansion device having at least one expansion unit, and supplying power to the expansion device, wherein the portable electronic device controls supply of power by the expansion device to the at least one expansion unit.

According to the present invention, there is provided a power management method to be implemented by a portable electronic device. The portable electronic device is coupled to an expansion device having at least one expansion unit, and supplies power to the expansion device. The power management method comprises the steps of:

(A) configuring the portable electronic device to detect whether a control command is received thereby;

(B) configuring the portable electronic device to transmit a control signal corresponding to the control command to the expansion device in response to the control command; and

(C) configuring the expansion device to switch the at least one expansion unit from a first power supply state to a second power supply state in accordance with the control signal.

In an embodiment of the invention, the first power supply state is an on state, the second power supply state is an off state, and in step (C), the expansion device is configured to switch the at least one expansion unit from the on state to the off state in accordance with the control signal.

In an embodiment of the invention, the first power supply state is an off state, the second power supply state is an on state, and in step (C), the expansion device is configured to switch the at least one expansion unit from the off state to the on state in accordance with the control signal.

Preferably, the control command is issued by pressing a hot key of the portable electronic device.

Preferably, in step (B), the portable electronic device is configured to transmit the control signal to the expansion device through a system management bus (SMbus).

The merit of the present invention resides in using the portable electronic device to control the expansion device to cease supplying power to the expansion unit that is not in use so as to conserve power.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic circuit block diagram of a preferred embodiment of the portable electronic device according to the present invention; and

FIG. 2 is a flowchart of a preferred embodiment of the power management method according to the present invention.

### DETAILED DESCRIPTION OF THE PREFERRED EMBODIMENT

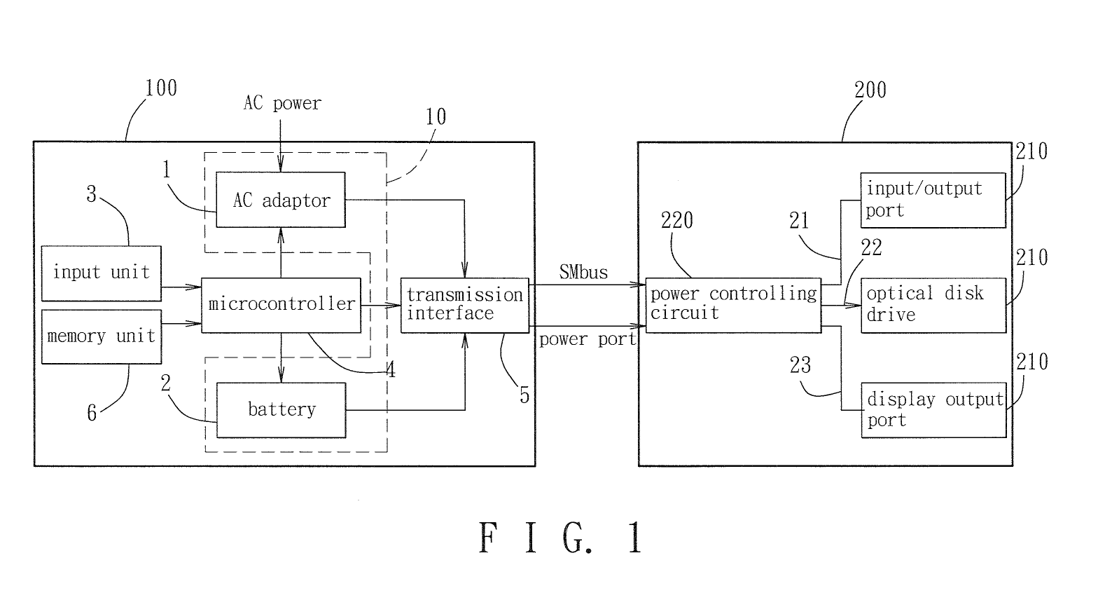

FIG. 1 illustrates the preferred embodiment of the portable electronic device 100 according to the present invention. The portable electronic device 100 is adapted for coupling with an expansion device (dock) 200, which is used to expand functionality of the portable electronic device 100. The portable electronic device 100 is adapted for supplying power to the expansion device 200. The expansion device 200 has at least one expansion unit 210, such as a hard drive, optical disk drive, etc., and a power controlling circuit 220. The power controlling circuit 220 receives power from the portable electronic device 100 and is operable to control supply of power to the at least one expansion unit 210. The portable electronic device 100 accepts control from a user for turning on or off the at least one expansion unit 210 of the expansion device 200 so as to manage and conserve power.

The portable electronic device 100 can be a notebook computer, global positioning system (GPS) receiver, portable music player, etc., and comprises a power supplying unit 10 and microcontroller 4. The power supplying unit 10 is for supplying power to the portable electronic device 100. The microcontroller 4 is for outputting a control signal corresponding to a control command, and transmitting the control signal to the power controlling circuit 220 of the expansion device 200. The power controlling circuit 220 controls the supply of power to the at least one expansion unit 210 in accordance with the control signal so that the at least one expansion unit 210 is switched from a first power supply state to a second power supply state.

In this embodiment, the portable electronic device 100 further comprises an input unit 3 coupled to the microcontroller 4, and the power supplying unit 10 includes an AC adaptor 1 and a battery 2.

The power supplying unit 10 supplies power from either the AC adaptor 1 or the battery 2 for meeting power requirements of the portable electronic device 100. The AC adaptor 1 receives AC power and outputs a converted voltage to the portable electronic device 100. The battery 2 comprises one storage cell or many series/parallel connected storage cells, although implementation of the battery 2 is not limited to such, and stores power to be supplied to the portable electronic device 100.

The input unit 3 is preferably a keyboard 3 having a plurality of hot keys (not shown) corresponding to the at least one expansion unit 210, and pressing the hot keys results in output of the corresponding control commands to the microcontroller 4.

In this embodiment, the microcontroller 4 includes an embedded controller (EC), keyboard controller (KBC), etc. for receiving the control command and outputting the control signal corresponding to the control command to the expansion device 200. The embedded controller controls either the AC adaptor 1 or the battery 2 to supply power to the portable electronic device 100. When the embedded controller of the microcontroller 4 detects that the portable electronic device 100 is connected to an external power source through a power cord (not shown), the embedded controller controls the AC adaptor 1 to supply power to the portable electronic device 100. On the other hand, when the embedded controller of the microcontroller 4 detects no connection to the external power source, then the embedded controller controls the battery 2 to supply power to the portable electronic device 100.

In this embodiment, the expansion device 200 is connected externally to the portable electronic device 100 and includes three expansion units 210: an input/output port (such as a USB hub or USB port), an optical disk drive, and a display output port, such as a serial digital video output (SDVO). The power controlling circuit 220 has a plurality of power supplying pins 21,22,23 that are electrically and respectively coupled to the input/output port, optical disk drive, and display output port for supplying power thereto.

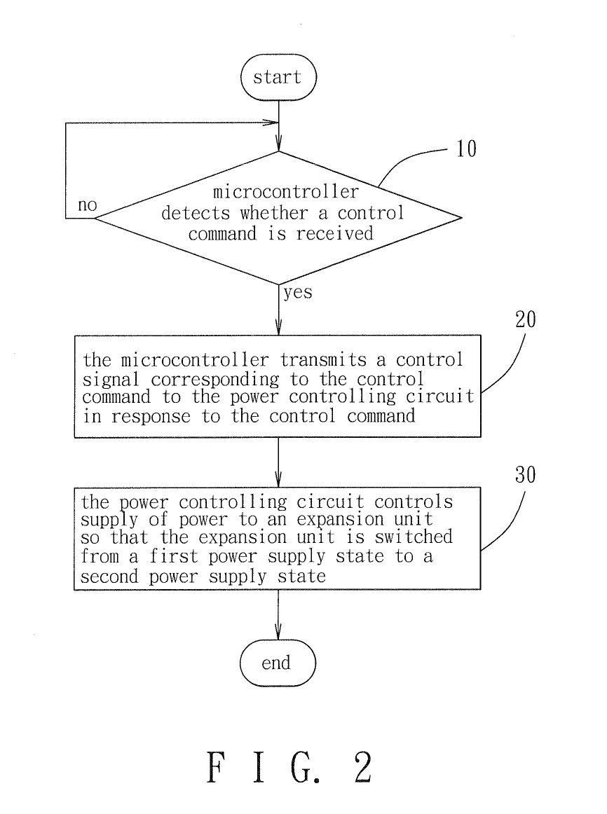

FIG. 2 illustrates the power management method according to the present invention. The method is to be implemented by the portable electronic device 100 and comprises the following steps.

In step 10, the microcontroller 4 detects whether the control command from the input unit 3 is received thereby. When the control command is detected, the flow proceeds to step 20. Otherwise, the flow returns to step 10. It is noted that, in this embodiment, the control command issued by pressing one of the hot keys correspondingly controls at least one of the expansion units 210, and the manner in which the hot keys are designed to issue the control commands can be decided by one implementing this invention. For example, a first hot key comprising Fn+F1 can correspond to supply of power to the input/output port, a second hot key comprising Fn+F2 can correspond to supply of power to the optical disk drive, and a third hot key comprising Fn+F3 can correspond to supply of power to the display output port. Accordingly, the microcontroller 4 is able to detect the control commands corresponding to these hot keys and transmit the corresponding control signals. It is also worth noting that the input unit 3 can be a graphical user interface (GUI) that provides the user with a menu of options. However, implementation of the input unit 3 is not limited to what has been disclosed herein.

In step 20, the microcontroller 4 transmits the control signal corresponding to the control command to the power controlling circuit 220 of the expansion device 200. It should be noted that, in this embodiment, the portable electronic device 100 further includes a transmission interface 5 coupled to the microcontroller 4 and the power supplying unit 10 for transmitting the control signal and a power signal to the expansion device 200. Preferably, the transmission interface 5 has a system management bus (SMbus) and a power port for transmitting to the power controlling circuit 220 the control signal outputted by the microcontroller 4 and the power signal from the power supplying unit 10, respectively.

In step 30, the power controlling circuit 220 controls the supply of power to at least one of the expansion units 210 in accordance with the control signal so that the at least one of the expansion units 210 is switched from the first power supply state to the second power supply state. In this embodiment, the first power supply state is an on state (an operating state), and the second power supply state is an off state. Assuming that each of the expansion units 210 is initially in the on state, the power controlling circuit 220 ceases to supply power to at least one of the expansion units 210 in accordance with the control signal. It should be noted that the power controlling circuit 220 supplies different voltages of power (such as 3.3V, 5V, etc.) to different ones of the expansion units 210.

Therefore, in operation, when the user presses the hot key corresponding to the expansion unit 210 that is not in use (which results in output of the corresponding control command), the microcontroller 4 outputs the control signal corresponding to the control command to the power controlling circuit 220, and the power controlling circuit 220, in response, ceases to supply power to this expansion unit 210 so that a power saving effect is achieved. It is noted that when the battery 2 supplies power to the portable electronic device 100, ceasing supply of power to the expansion unit 220 that is not in use conserves the power stored in the battery 2. Moreover, it is worth mentioning that the quantity of the expansion units 210 correspondingly controlled by the hot keys is not limited to a one-to-one ratio, and can be a one-to-many or many-to-one ratio depending on different requirements, and is thus not limited to what is disclosed herein.

In addition, the first power supply state can be the off state and the second power supply state can be the on state. In this case, when the user needs to use one of the expansion units 210 that has been switched to the off state, the user only needs to press the corresponding hot key again (or press another activate key). The microcontroller 4 then outputs the corresponding control signal to the power controlling circuit 220, and the power controlling circuit 220, in accordance with the control signal, supplies power to this expansion unit 210 so that this expansion unit 210 is switched to the on state.

In operation, when the expansion device 200 is externally connected to the portable electronic device 100, all or a portion of the expansion units 210 can initially be in the off state (i.e., not supplied with power). Using the steps described above, these expansion units 210 can be switched to the on state (i.e., supplied with power) by pressing the corresponding hot keys on the input unit 3 so that the microcontroller 4, in accordance with the control command, controls the power controlling circuit 220 to supply power to these expansion units 210. Preferably, the portable electronic device 100 further has a recording unit 6 coupled to the microcontroller 4 for recording a current power supply state of each of the expansion units 210. Software settings in the keyboard controller of the microcontroller 4 can be set so that the recording unit 6 maintains a record of the power supply states of each of the expansion units 210 after the expansion unit 200 has been disconnected from the portable electronic device 100, so that when the expansion unit 200 is later reconnected to the portable electronic device 100, the previous power supply states of the expansions units 210 can be restored without user involvement.

In summary, since the portable electronic device 100 of this invention has hot keys corresponding to the expansion units 210 for controlling the power supply states of the expansion units 210, the user can turn off the expansion unit 210 that is not in use by pressing the corresponding hot key, thereby saving power and conserving service life of the battery 2.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A power management method to be implemented by a portable electronic device, the portable electronic device being coupled to an expansion device having at least one expansion unit, and supplying power to the expansion device, said power management method comprising the steps of:
(A) configuring the portable electronic device to detect whether a control command is received thereby;
(B) if the control command is received by the portable electronic device in step (A), configuring the portable electronic device to transmit a control signal corresponding to the control command to the expansion device in response to the control command; and
(C) configuring the expansion device to switch the at least one expansion unit from a first power supply state to a second power supply state in accordance with the control signal.

2. The power management method as claimed in claim 1, wherein the first power supply state is an on state, the second power supply state is an off state, and in step (C), the expansion device is configured to switch the at least one expansion unit from the on state to the off state in accordance with the control signal.

3. The power management method as claimed in claim 2, wherein the control command is issued by pressing a hot key of the portable electronic device.

4. The power management method as claimed in claim 3, wherein, in step (B), the portable electronic device is configured to transmit the control signal to the expansion device through a system management bus.

5. The power management method as claimed in claim 1, wherein the first power supply state is an off state, the second power supply state is an on state, and in step (C), the expansion device is configured to switch the at least one expansion unit from the off state to the on state in accordance with the control signal.

6. The power management method as claimed in claim 5, wherein the control command is issued by pressing a hot key of the portable electronic device.

7. The power management method as claimed in claim 6, wherein, in step (B), the portable electronic device is configured to transmit the control signal to the expansion device through a system management bus.

8. A portable electronic device adapted for coupling with an expansion device and supplying power to the expansion device, the expansion device having a power controlling circuit and at least one expansion unit, the power controlling circuit receiving power from said portable electronic device and being operable to control supply of power to the at least one expansion unit, said portable electronic device comprising:
a power supplying unit for supplying power to said portable electronic device; and
a microcontroller for outputting a control signal corresponding to a control command, and transmitting the control signal to the power controlling circuit of the expansion device, the power controlling circuit controlling the supply of power to the at least one expansion unit in accordance with the control signal so that the at least one expansion unit is switched from a first power supply state to a second power supply state.

9. The portable electronic device as claimed in claim 8, wherein the first power supply state is an on state, the second power supply state is an off state, and when said microcontroller transmits the control signal to the power controlling circuit of the expansion device, the power controlling circuit, in accordance with the control signal, ceases to supply power to the at least one expansion unit so that the at least one expansion unit is switched from the on state to the off state.

10. The portable electronic device as claimed in claim 9, further comprising an input unit coupled to said microcontroller and operable to output the control command.

11. The portable electronic device as claimed in claim 10, wherein said input unit is a keyboard having a plurality of hot keys corresponding to the at least one expansion unit, and pressing said hot keys results in output of the control command.

12. The portable electronic device as claimed in claim 11, further comprising a transmission interface coupled to said microcontroller and said power supplying unit for transmitting the control signal and a power signal to the expansion device.

13. The portable electronic device as claimed in claim 12, wherein said transmission interface has a system management bus for transmitting the control signal.

14. The portable electronic device as claimed in claim 13, further comprising a memory unit coupled to said microcontroller for recording a current power supply state of the at least one expansion unit of the expansion device.

15. The portable electronic device as claimed in claim 8, wherein the first power supply state is an off state, the second power supply state is an on state, and when said microcontroller transmits the control signal to the power controlling circuit of the expansion device, the power controlling circuit, in accordance with the control signal, supplies power to the at least one expansion unit so that the at least one expansion unit is switched from the off state to the on state.

16. The portable electronic device as claimed in claim 15, further comprising input unit coupled to said microcontroller and operable to output the control command.

17. The portable electronic device as claimed in claim 16, wherein said input unit is a keyboard having a plurality of hot keys corresponding to the at least one expansion unit, and pressing said hot keys results in output of the control command.

18. The portable electronic device as claimed in claim 17, further comprising a transmission interface coupled to said microcontroller and said power supplying unit for transmitting the control signal and a power signal to the expansion device.

19. The portable electronic device as claimed in claim 18, wherein said transmission interface has a system management bus for transmitting the control signal.

20. The portable electronic device as claimed in claim 19, further comprising a memory unit coupled to said microcontroller for recording a current power supply state of the at least one expansion unit of the expansion device.
